(19) United States
(12) Patent Application Publication
(10) Pub. No.: US 2010/0289743 A1
(43) Pub. Date: Nov. 18, 2010

(54) LASER POINTER AND GESTURE-BASED INPUT DEVICE

(75) Inventors: ALBERT C. SUN, Hsinchu (TW); Chungming Glendy Sun, Hsinchu (TW)

Correspondence Address: HAYNES BEFFEL & WOLFELD LLP, P O BOX 366, HALF MOON BAY, CA, 94019, US

(73) Assignee: AFA Micro Co., Chutung (TW)

(21) Appl. No.: 12/466,692

(22) Filed: May 15, 2009

(51) Int. Cl. G06F 3/033

(52) U.S. Cl. 345/158; 715/863

(57) ABSTRACT

A laser pointer is combined with a gesture-based input system to enable presenters to make a seamless presentation, using the laser pointer to highlight content on a screen and in addition as a mount for a motion sensor comprising at least one small sensor such as a micro-electromechanical sensor MEMS that is used as an input device for delivering commands to a host computer.

### BACKGROUND OF THE INVENTION

1. Field of the Invention

The present invention relates to a gesture-based laser pointer system for user-application interfaces.

2. Description of Related Art

Public speaking and making presentations to an audience are stressful tasks, even to the most skilled public speakers. It is important for a person making a presentation to focus completely on the audience in order to completely and effectively convey his or her message. The stress levels for presenters are multiplied several times when they also have to manage a presentation, such as a PowerPoint presentation, in addition to making a persuasive pitch to their audience.

A presenter making a PowerPoint presentation has a problem of talking to the audience and navigating through the presentation at the same time. In many cases, it requires two people to make a presentation—one who is making the speech and the other who controls the presentation slides. It is difficult to make a seamless presentation when a presenter has to coordinate between the content of his speech and matching the content of his speech with the slide on the screen.

It is extremely distracting to the presenter to multitask while already performing the difficult task of public speaking in front of a group of people. A presentation system is desired where the presenter can make a seamless presentation without having to click on a mouse to change the display image on the screen while he is also talking to his audience.

### SUMMARY

The presenter is given a tool that is useful for highlighting locations on the screen in real time, and the power to navigate the presentation with only one hand-held device. A laser pointer is combined with a gesture-based input system that is used as an input device for delivering commands to a host computer to enable presenters to make a seamless presentation, using the laser pointer to highlight content on a screen and in addition as a mount for a motion sensor used for the gesture-based input.

The laser point includes a laser and a motion sensor comprising at least one small sensor such as a micro-electromechanical sensor MEMS, along with a signal accumulation unit connected to the sensor on the laser pointer. The signal accumulation unit includes logic for packaging data from the motion sensor to produce packaged data. The signal accumulation unit also includes a communication port for communicating with a host computer by which the packaged data is sent to the host. The host computer includes resources that, in cooperation with the processing at the signal accumulation unit, interpret the gesture input data, and generate a resulting input signal. The input signal is then delivered by the host to a target system using an appropriate computer generated message. Representative target systems include such programs as business presentation software, software managing audio visual equipment, and so on.

As described herein, a laser pointer device with a gesture input system produces commands used by presentation software. A library of gestures is described which are interpreted as commands for the presentation program, including for example commands for advancing a presentation to a next page, or for returning to a previous page. These gestures are easy to execute using a laser pointer device, and can address problems associated with the dexterity required for controlling the presentation equipment while also delivering the presentation as described above.

The motion sensor can be implemented using one or more MEMS elegantly utilized to produce data in one or more than one spaces, where a space includes at least two dimensions sampled over time, including displacement, velocity and acceleration for translation in linear space and displacement, velocity and acceleration for rotation in angular space. The use of multiple space analysis using gesture data in more than one space from multiple sensors mounted at different locations, and/or more than one space from one or more sensors mounted at a single location, for analysis of gestures improves the power of the recognition systems significantly, enabling the interpretation of complex gestures. Multiple space analysis interprets various laser pointer movements to perform specific actions, in addition to next page or previous page commands, such as scrolling a slide from side to side or up and down, zooming on a feature of a page, flipping a page on screen or highlighting other features of a presentation.

A host computer system is described that includes an interface for communication with a signal accumulation unit on a user, and resources for interpreting the data in multiple spaces. Resources include, in addition to data processing hardware, a database of gesture specifications including one or more specifications of gestures in multiple spaces, and programs for comparing input data to the specifications in the database. Also, resources in the host include communication resources for composing a message including the results of interpretation of the gesture data, and sending the message to a target where the data is utilized as an input command or data.

The presenter is able to navigate a presentation program using a gesture-sensing laser pointer in real time (i.e. without interrupting the presentation by stopping to find a switch on the projector or computer), improving the interactivity with the audience. Also, the gesture-sensing laser pointer gives the presenter better control over the mood and pace of the presentation.

Other aspects and advantages of the present invention are provided in the drawings, the detailed description and the claims, which follow.

### BRIEF DESCRIPTION OF THE DRAWINGS

FIG. 1 is a simplified diagram of a man-machine interface based on gestures.

FIG. 2 is a simplified diagram of a laser pointer with the signal accumulation unit located on it.

FIG. 3 is a block diagram of a micro-sensor signal accumulation unit for man-machine interface systems as described herein.

FIG. 4 is a block diagram of a host computer for man-machine interface systems as described herein.

FIG. 5 provides a flow chart illustrating a method of operation for man-machine interface systems as described herein.

FIG. 6 is a block diagram of a machine readable medium with a program stored on it, which is part of a kit including the gesture-sensing laser pointer.

FIG. 7 is a block diagram of the laser pointer depicting the movement of the laser pointer in up/down and left/right directions to form simple gestures to indicate specific commands.

### DETAILED DESCRIPTION

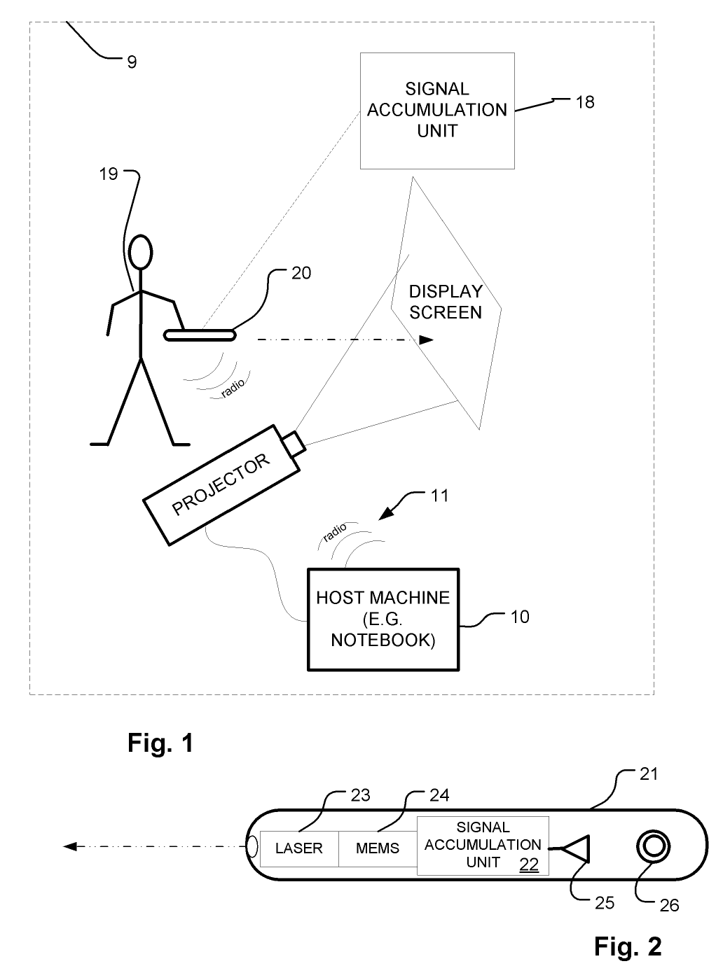

FIG. 1 is a simplified diagram of a man-machine interface based on gestures which are executed in an environment 9. A user 19 holds a laser pointer 20 which has a motion sensor and a signal accumulation unit 18 residing on it. The laser pointer 20 uses wireless signal 11 to communicate with the host machine 10. A host machine 10, such as a personal computer, or other device having a graphical user interface or display, communicates with a sensor system which is attached to the laser pointer. The sensors include, in preferred implementations, very small MEMS sensors mounted on the laser pointer 20 which are connected by wires or wirelessly to a signal accumulation unit 18 that packages data from the sensors and transmits the packaged data to the host machine using a wireless signal 11 using a communication link technology like Bluetooth or an infrared communication link. Some embodiments may also use wired connections if desired.

As used in the description of the present invention, a laser pointer is broadly construed to include a pointer that emits a beam of any collimated or highly focused visible light pointing device and is not limited to a beam light created by a laser. Also, contemporary presentations typically comprise a series of frames or slides such as created by PowerPoint sold by Microsoft Corporation. Each slide can include still images, animation or incorporate video for informing or entertaining the audience. As used herein, however, any form of presentation is contemplated for use with the present invention.

Because of the very small size and low weight of the sensors and supporting circuitry, the sensor units may be attached to, or mounted on or within, the laser pointer. The laser pointer could include a laser pointer or a similar device which is used to assist in presentations.

Representative sensor units include inertial sensors and gyroscopes capable of sensing up to 6 degrees of motion, including translation on the x-, y- and z-axes, and rotation on the x-, y- and z-axes. The motion can be interpreted by breaking down the sensor data in displacement, velocity and acceleration spaces for both translation and rotation. Many sensors, sensing many axes and types of motion, can provide substantial information to be used for enhancing the quality of presentations by flipping the page or slide with one gesture, moving up and down the screen with another gesture, controlling video functions, such as volume, rewind, forward, and for distinguishing between gestures. In addition, a single sensor can provide input in both linear and angular acceleration space, velocity space, and displacement space, giving rich input data practically unavailable in prior art vision-based systems.

For the purposes of this specification, a micro-electromechanical sensor MEMS is any one of a class of sensors consisting of a unit that is small and light enough to be attached to a laser pointer, and can be defined as die-level components of first-level packaging, and include pressure sensors, accelerometers, gyroscopes, microphones, etc. Typical MEMS include an element that interacts with the environment, having a width or length on the order of 1 millimeter, and can be packaged with supporting circuitry such as an analog-to-digital converter, a signal processor and a communication port.

Representative MEMS suitable for the gesture-based laser pointer described herein include two axis accelerometers. For a given application, two of such accelerometer sensors can be mounted in a single location to sense multiple three of linear acceleration. Other representative MEMS for the gesture-based systems described herein include gyroscopes, including piezoelectric vibrating gyroscopes.

The host machine 10 and the signal accumulation unit 18 comprise data processing resources which provide for interpretation of the gesture data received from the sensors located on the laser pointer. In some embodiments, the signal accumulation unit 18 performs more interpretation processing than in other embodiments, so that the host machine 10 performs different amounts of interpretation processing depending on the complementary processing at the signal accumulation unit 18. The interpreted gesture data is processed by the host to produce a specific signal. The host machine 10 determines the specific signal as the result of the interpreted gesture data determines the target for that specific signal and issues the resulting signal to the target. The target may comprise a display screen formed by a projector, computer program running on the host machine 10 or running on other systems operating in the environment of the user, with which the user is interacting via the gesture language. Thus, the gesture data is delivered from the user to the host machine to the environment, and used for controlling the projector screen in the environment, including translating the gesture language into signals controlling audiovisual devices.

The host machine 10 also includes resources which act as a feedback provider to the user. This results in an interaction loop in which the user provides a gesture signal to the host machine, which interprets the signal and produces a response. For example, the user makes a gesture with the laser pointer, the MEMS with gesture sensing capability located on the laser pointer, to go to the next slide or page in the presentation. The signal accumulation unit interprets gesture data commands from the user such as ‘go to next page’ or ‘go to previous page.’ The translated message is then wirelessly sent to the computer where it is interpreted as the ‘go to next page’ or ‘go to previous page’ command and then executed by the PowerPoint, or other type of similar application, to update the displayed image. This enables the user to move smoothly through his or her presentation without having to worry about managing the presentation loaded on the computer and effectively communicating his or her message to the audience at the same time.

The host machine 10 can include a map database including the specifications of gestures to be used with the laser pointer, and a mapping of the gestures to specific signals. A pre-specified gesture in the database can be defined as a movement of the laser pointer from left side to right side which can be associated with the function of skipping ahead to the next slide in the presentation. Similar gestures can be pre-defined to be associated with a particular function to be performed by the laser pointer. The host machine 10 may include a computer program that provides an interactive learning process, by which the user is presented with the specifications of the specific gesture on the laser pointer, and then makes the gesture on the laser pointer in an attempt to match the presented specifications. This provides a learning loop in which the computer enables a user to learn a library of gestures for interaction with the computer system.

The host machine 10 can include an interactive program, by which a user defines the specifications of gestures to be utilized. A specific gesture with the laser pointer can be defined to be interpreted as highlighting the document or emphasizing a word or for other similar presentations.

A system as described herein can be implemented using sensors that describe motion of the sensor in space, including providing gesture data concerning up to 6 degrees of freedom, including 3 degrees of freedom in translation in linear space provided by accelerometer and 3 degrees of freedom provided in rotation in angular space by a gyroscope. It is also possible, theoretically, to describe the displacement of an object in space using an accelerometer for all 6 degrees of freedom, or using a gyroscope for all 6 degrees of freedom. Using multiple spaces provided by sensing function with respect to up to 6 degrees of freedom, can enable a system to distinguish between complex gestures reliably and quickly. The gesture data produced during movement of the sensors, located on the laser pointer, through a given gesture can be analyzed by displacement, velocity, acceleration in linear and angular spaces.

For example, if the MEMS-based sensors detect specific gestures made using the laser pointer, the presentation page can be moved up and down. If a video is being displayed on the display screen, then specific gestures can be used on the laser input device to skip the video forward or backward or increase or decrease the volume of the video.

If the user rotates the laser pointer in space, with near constant angular speed in the time domain, then the motion will appear as a fixed spot in angular velocity space. The motion will also appear as a fixed spot at (0,0,0) in angular acceleration space, e.g. it has zero angular acceleration across a time domain.

For another example, if the user draws a linear line in space with the laser pointer, with constant linear speed in the time domain, then the motion will appear as a fixed spot in linear velocity space. The motion will also appear as a fixed spot at (0,0,0) on linear acceleration space, e.g. it has zero linear acceleration across time domain.

FIG. 2 is a block diagram of the laser pointer 21 with a laser 23, a MEMS 24 and the signal accumulation unit 22 mounted thereon. An antenna 25 is built in on the laser pointer 21, and coupled to the radio in the signal accumulation unit 22. A button switch 26 is placed on the laser pointer 21, and used to turn on and off the laser, and as an orientation marker for the MEMS 24. The signal accumulation unit 22 is connected to the MEMS sensor 24. The signal accumulation unit includes logic for packaging data from the sensor or sensors, including data in multiple spaces, and data from multiple sensors about a gesture sensed at the sensor, or sensors, to produce packaged data. The signal accumulation unit also includes a communication port for communication with a host computer by which the packaged data is sent to the host. Although not shown, the laser pointer includes a battery or batteries. The button switch 26 can be a multimode switch, or an additional switch can be mounted on the laser pointer with a pre-specified orientation relative to the sensor, and used by the user to enable and disable gesture detection. For example, the switch is engaged by the user at the beginning of a gesture to be interpreted as a command, and disengaged at the end of the gesture. The signal accumulation unit can include logic responsive to the switch to delineate data about movement of the pointer to be used for detection of gestures.

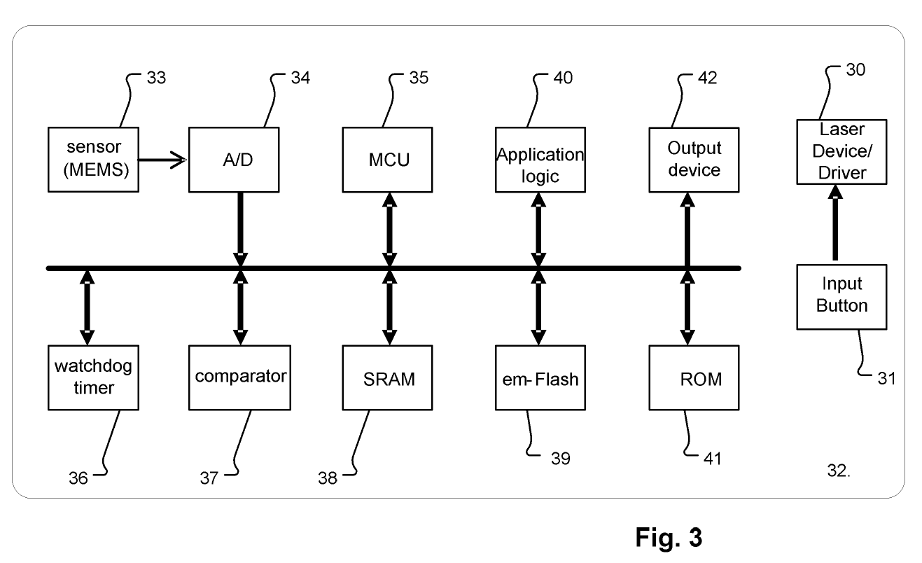

FIG. 3 is a block diagram of a MEMS sensor-based gesture-sensing system mounted on or within a casing 32 for the laser pointer. The laser pointer gesture-sensing system includes a MEMS sensor 33 which is coupled to analog-to-digital conversion circuit 34. Alternative systems include more than one sensor. The MEMS sensor unit 33 may comprise inertia sensors such as accelerometers and gyroscopes, for example. The conversion circuit 34 is coupled to a bus on which a microcontroller unit MCU 35 coordinates activity among a number of units, executing system firmware and coordinating processing with application logic for the gesture navigation. In the illustrated example, other units on the bus include a watchdog timer 36, comparator logic 37, for comparing input sequences of data indicating gestures or component motions of gestures that include a sequence of component motions, with stored sequences of data specifying the unique signatures for memorized gestures for component motions, SRAM 38 working memory used for example to store displacement, velocity and acceleration data for gestures as they are performed, embedded flash memory 39 to store a component motion database and application programs to support self-learning and calibration, any necessary application logic 40 to operate as glue logic or high speed logic in support of the gesture interpretation and navigation processes, in addition to that provided by the microcontroller unit, ROM memory 41 for storing instructions or other control data, and an output device 42 for communicating with a host computer. The watchdog timer 36 is operable to set time limits on the processes for interpreting gestures, to eliminate or recover from invalid commands. The output device 42 can be an analog or digital channel, such as a Bluetooth module, infrared module, a WIFI module or other wireless or wired link capable of communicating the gesture input data. A laser/laser driver 30 is mounted on the casing 32, as well as an input button 31 for turning on an off the laser.

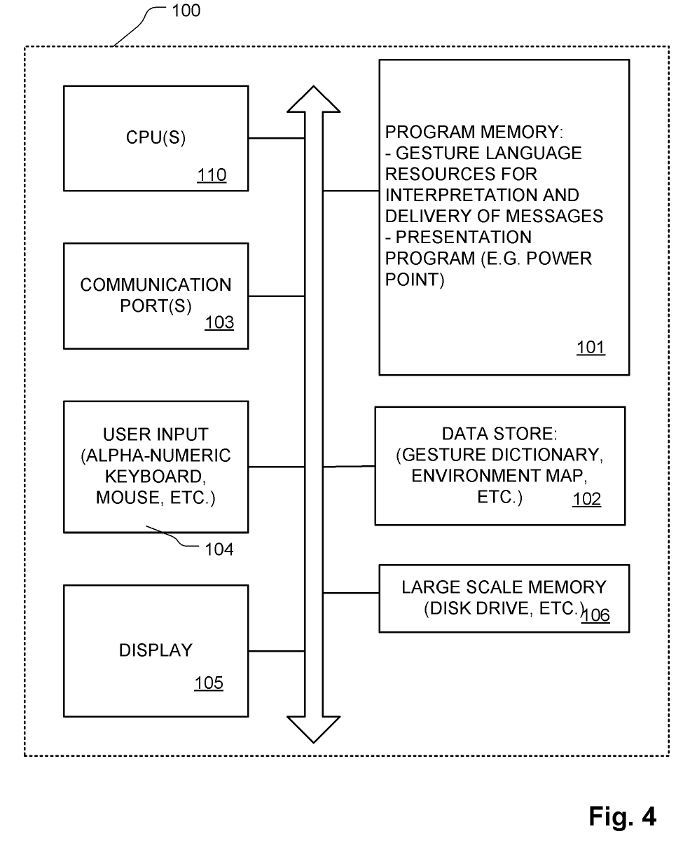

FIG. 4 is a simplified block diagram of a data processing system 100 arranged as a host computer for a laser pointer/gesture input device system as described herein. The system 100 includes one or more central processing units 110, which are arranged to execute computer programs stored in program memory 101, access a data store 102, access large-scale memory 106 such as a disk drive, and to control communication ports 103, including a port for communication with a signal accumulation unit 10 as shown in FIG. 1, standard user input devices 104, and a display 105.

The presentation program and optional gesture analysis processes use data processing resources including logic implemented as computer programs stored in memory 101 for an exemplary system. In alternatives, the logic can be implemented using computer programs in local or distributed machines, and can be implemented in part using dedicated hardware or other data processing resources. The logic in a representative gesture analysis system includes resources for interpretation of gesture data and for delivery of messages carrying signals that result from the interpretation, and resources for gesture language learning and self-learning processes. The presentation process can be a program such as PowerPoint, with pre-specified application program interfaces for accepting commands, such as next page, previous page, zoom, pan and so on, from other programs and input devices, such as the gesture-sensing laser pointer described herein. Presentation programs also support video clips or movies, in which commands are accepted for fast forward, reverse, pause, and up/down volume controls that can be produced using the gesture-sensing laser pointer.

The data store 102 is typically used for storing a machine-readable gesture dictionary including definitions of gestures on the laser pointer and other data intensive libraries. Large-scale memory is used to store multiple gesture dictionaries for example, and other large scale data resources.

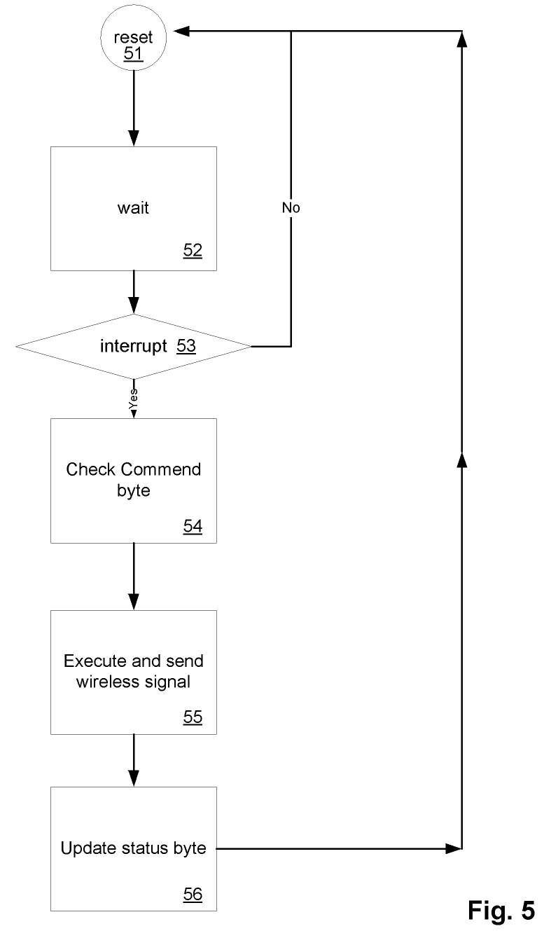

FIG. 5 provides a flow chart showing a simplified operation sequence for the system in which the various steps can be executed by a process at the sensors, a processor in the signal accumulation unit, a processor in the host computer, or a processor available to the system for the purpose stated. The process begins on power-up or initialization of the MEMS and signal accumulation unit. If the system successfully powers up, (i.e., no system abort), then a calibration is optionally executed. If the system does not successfully power up, then the logic will enter a “reset” mode 51. After the system is reset, it waits 52 to see if the system gets interrupted 53 such as in response to detection of motion. If it does not get interrupted, then the system goes back to reset. An interrupt can be generated in response to detection of motion by the MEMS on the gesture-sensing laser pointer. Upon such interruption, input from the sensors 54 is received by the signal accumulation unit, and processed to check a command byte which can be a specific command for a presentation program, or a command indicating detection of a component gesture or other pre-specified commands that can be sent to a complementary driver on the host machine. A wireless signal carrying the command byte is then sent to the host 55, which responds according to the communication control indicating successful receipt of the message, completion of processing of the command or other factors, and then logic updates command status 56 to return the control to the wait state.

During the wait state, input from the sensors is gathered, filtered and analyzed to determine whether valid gesture input signals are received. The input signals can be delineated using mechanical or audio signals, or recognized as a result of specific gesture commands, or the like. The input data can be further formatted for interpretation of displacement, velocity and acceleration along various linear and angular axes as mentioned above. The resulting data is then compared with information in a gesture or component motion database. If a match is discovered, then an output command byte is produced and delivered to the host computer as a gesture language/instruction command at system output.

After the gesture or component motion has been interpreted and delivered to the host system, the host system can apply further processing to identify the intended input signal, such as for gestures that comprise a sequence of component motions, or in the case that the gesture is fully identified in the signal accumulation unit, sends a message to a target process which executes a command indicated by the signal, or processes the data indicated by the signal appropriately.

The MEMS sensor units are ultra light, and very small so that they can be easily attached to the laser pointer. This technology makes it possible to shift between pages or slides in a presentation and control video outputs by a single gesture of holding the laser pointer. Also, sophisticated gestures can be utilized through sensing displacement, velocity, acceleration and both linear and angular spaces. The system is capable of learning user-defined gestures for customized user language and commands.

Another embodiment of this system includes a kit where the laser pointer system is coupled with a computer program stored on a machine readable medium such as DVD, CD, floppy disk or similar storage devices. The computer program in the kit manages the communication with the signal accumulation unit located on the pointer using a Bluetooth driver and command translator. This software program can be uploaded to a computer in order to enable the computer to translate the message sent to it by the signal accumulation unit located on the laser pointer to update the presentation in accordance with the specific gesture provided by the user and interpreted by the signal accumulation unit.

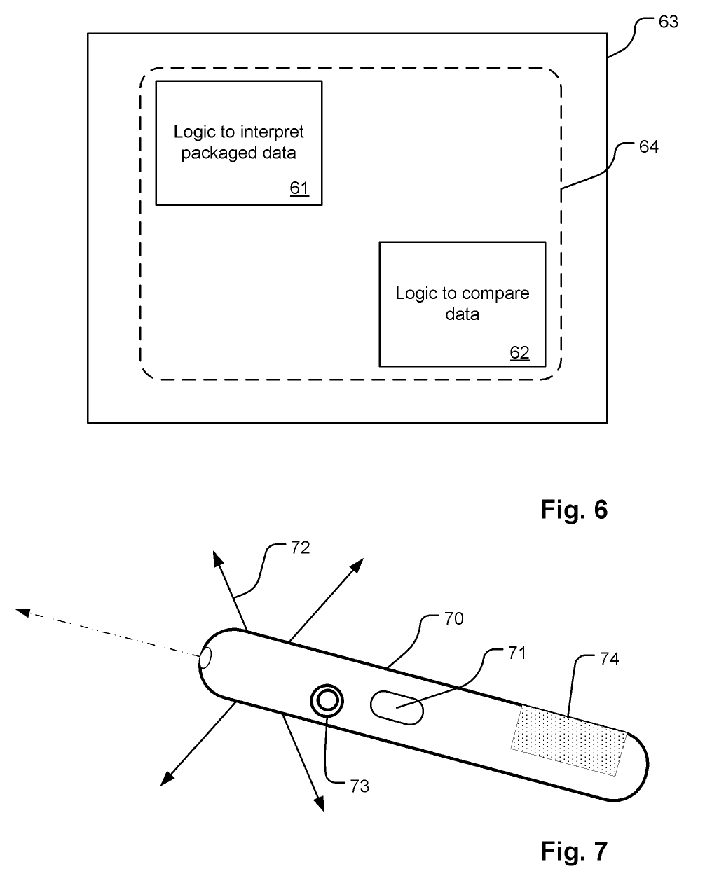

FIG. 6 is a block diagram of a machine readable medium with a program stored on it, which is part of a kit including the gesture-sensing laser pointer of FIG. 2. The program is loaded on the host computer in order to enable it to recognize the pre-specified gestures that exist in the database. The machine readable medium 63 can be any physical device on which a program can be stored. Such devices include CDs, DVDs, floppy disks, or similar storage devices. The machine readable medium 63 has a computer program 64 loaded on it which enables the host computer to understand a pre-specified gesture of the laser pointer and perform the desired function.

The computer program 64 includes drivers used to adapt the host computer to the system requirements of running the computer program. The computer program 64 further includes a database which contains pre-specified motions and their associated functions. The computer program can include logic 62 to compare data that it receives from the laser pointer MEMS and the signal accumulation unit with the pre-specified motions in the database. The program then finds the appropriate function that is triggered when the program finds a match between the pre-specified gesture and the gesture received from the laser pointer.

After the program has found the match between the database components and the pre-specified gesture, the logic 61 such as a Bluetooth compatible driver, to interpret this packaged data is applied to produce a resulting signal and to send the signal to the presentation program being executed on the host computer. In embodiments in which the gesture-sensing laser pointer packages signals indicating components of gestures, the program 64 includes logic 62 to compare the data from the gesture-sensing laser pointer to signature files for specific gestures, and to produce commands for, and to send the commands to, the presentation program. For instance, the presenter could have moved the laser pointer from left to right indicating that he wants to load the next slide on the display screen. The resulting signal would comprise a “next page” command forwarded to the presentation program, which executes the next page process.

Some examples of the presentation program using the resulting program are discussed. A user using the standard Microsoft PowerPoint presentation can use this technology to hold the laser pointer in his/her hand while making a presentation. Assuming that the presentation is being displayed to an audience on a projector screen or other kind of display screen, the user can casually talk to his audience and flick his hand to the left or right and move to the next slide. The transition seems more smooth and natural than if the presenter had to communicate with another person and that person had to move the slide for the presenter or if the presenter had to break the sequence of his presentation to go click on the computer to move the slide. Another example is a situation where the presenter wants to show the audience a video and wants to skip over unwanted parts of the video. Once again, the presenter can use the laser pointer to issue the rewind and forward commands to the presentation program without having to click on the computer and disrupt the flow of the presentation.

FIG. 7 is a block diagram of the laser pointer depicting the movement of the laser pointer in up/down and left/right directions to form simple gestures to indicate specific commands. Laser pointer 70 has MEMS sensor 71 and button 73, located on it. The button 73 is used as a laser beam switch and an orientation marker for the motion sensor 71. Of course, the orientation marker than be implemented by a feature on the housing of the laser pointer 70 other than the button 73, such as a painted symbol or a protruding member. The laser pointer 70 includes a housing in this example of which at least a portion 74 is non-metallic, allowing transmission of radio signals from in internal antenna. Arrows 72 depict the multi-dimensional nature of the laser pointer where the laser pointer can be moved and each motion can be sensed and interpreted by the signal accumulation unit to perform pre-specified functions such as move to the next page in the presentation, move to the previous page in the presentation, rewind the video embedded in the presentation, fast forward the video embedded in the presentation, increase or decrease audio volume (loudness). The specific command produced can depend on the state of the presentation program. For example, a flick from left to right can be interpreted as a next page command when the presentation program is causing display of a page based file, such as a set of slides, and can be interpreted as a fast forward command with the presentation program is displaying video. Also, with a more extensive library of gestures, more command types or sequences can be initiated based on gestures made using the gesture-sensing laser pointer.

A library of commands with corresponding gestures, and techniques for sensing the gestures is provided in the following table. Of course, the gestures listed can be mapped to a variety of commands, different that those listed in this table. For example, a gesture can be mapped to volume up and volume down commands for presentations that include audio. All of the presentation commands can be programmable.

Presentation Program Command Library

| | | MAPS TO | MOTION DETECTION |
|---|---|---|---|
| GESTURE | COMMAND | PRESENTATION | PROCESS (relative to |
| NUMBER | GESTURE NAME | COMMAND | orientation mark) |
| 1. | Left to Right Flick of | Move to a Next | Motion from left to right |
| | the Laser Pointer | Page | with reference to the beam |
| | | | line exceeding one or both |
| | | | of a threshold velocity or a |
| | | | threshold acceleration |
| 2. | Right To Left Flick | Move To A | Motion from right to left |
| | | Previous Page | with reference to the beam |
| | | | line exceeding one or both |
| | | | of a threshold velocity or a |
| | | | threshold acceleration |
| 3. | Slow Forward | Zoom In On A | Motion parallel to and in a |
| | Movement | Current Page | same direction as the |
| | | | beam line exceeding one |
| | | | or both of a first threshold |
| | | | velocity or a first |
| | | | threshold acceleration and |
| | | | below one or both of a |
| | | | second threshold velocity |
| | | | or a second threshold |
| | | | acceleration |
| 4. | Slow Backward | Zoom Out On A | Motion parallel to, and in |
| | Movement | Current Page | an opposite direction as, |
| | | | the beam line exceeding |
| | | | one or both of a first |
| | | | threshold velocity or a |
| | | | first threshold acceleration |
| | | | and below one or both of a |
| | | | second threshold velocity |
| | | | or a second threshold |
| | | | acceleration |
| 5. | Slow Upward (Bottom | Shift image up on | Upward motion |
| | to Top) Movement | display | orthogonal to the beam |
| | | | line exceeding one or both |
| | | | of a first threshold |
| | | | velocity or a first |
| | | | threshold acceleration and |
| | | | below one or both of a |
| | | | second threshold velocity |
| | | | or a second threshold |
| | | | acceleration |
| 6. | Slow Downward (Top | Shift image down | Downward motion |
| | to Bottom) Movement | on display | orthogonal to the beam |
| | | | line exceeding one or both |
| | | | of a first threshold |
| | | | velocity or a first |
| | | | threshold acceleration and |
| | | | below one or both of a |
| | | | second threshold velocity |
| | | | or a second threshold |
| | | | acceleration |
| 7. | Double Left To Right | Programmable | A sequence of motion |
| | Flick | (e.g., go to end) | within a pre-specified time |
| | | | interval including from |
| | | | two movements from left |
| | | | to right with reference to |
| | | | the beam line, both of said |
| | | | two movements exceeding |
| | | | one or both of a threshold |
| | | | velocity or a threshold |
| | | | acceleration |
| 8. | Double Right To Left | Programmable | A sequence of motion |
| | Flick | (e.g., go to | within a pre-specified time |
| | | beginning) | interval including from |
| | | | two movements from right |
| | | | to left with reference to |
| | | | the beam line, both of said |
| | | | two movements exceeding |
| | | | one or both of a threshold |
| | | | velocity or a threshold |
| | | | acceleration |
| 9. | Clockwise Circle | Video Play | Clockwise movement with |
| | Motion | Forward | reference to the beam line |
| | | | having a radius orthogonal |
| | | | to the beam line, and |
| | | | exceeding one or both of a |
| | | | threshold velocity or a |
| | | | threshold acceleration |
| 10. | Counter-Clockwise | Video Play | Counter-clockwise |
| | Circle Motion | Backward/Rewind | movement with reference |
| | | | to the beam line having a |
| | | | radius orthogonal to the |
| | | | beam line, and exceeding |
| | | | one or both of a threshold |
| | | | velocity or a threshold |
| | | | acceleration |
| 11. | Double Clockwise | Video Fast Forward | A sequence of motion |
| | Circle Motion | | within a pre-specified time |
| | | | interval including two |
| | | | clockwise movements |
| | | | with reference to the beam |
| | | | line having a radius |
| | | | orthogonal to the beam |
| | | | line, and exceeding one or |
| | | | both of a threshold |
| | | | velocity or a threshold |
| | | | acceleration |
| 12. | Double Counter- | Video Fast | A sequence of motion |
| | Clockwise Circle | Backward/Rewind | within a pre-specified time |
| | Motion | | interval including two |
| | | | counter-clockwise |
| | | | movements with reference |
| | | | to the beam line having a |
| | | | radius orthogonal to the |
| | | | beam line, and exceeding |
| | | | one or both of a threshold |
| | | | velocity or a threshold |
| | | | acceleration |

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention.

We claim:

1. A laser pointer device, comprising:
a laser pointer configured to emit a beam on a beam line;
a motion sensor attached to the pointer;
a signal accumulation unit connected to the motion sensor including logic which packages data about movement of the pointer sensed at the sensor to produce packaged data; and
a communication interface for communication with a host computer by which the packaged data is sent to the host computer.

2. The system of claim 1, including more than one motion sensor attached to the laser pointer.

3. The system of claim 1, wherein the motion sensor is a micro-electromechanical sensor.

4. The system of claim 1, wherein the communication interface includes a wireless link.

5. The system of claim 1, wherein said signal accumulation unit translates data from the sensor from analog to digital form, and assembles packets of digital gesture data, and said packaged data includes said packets.

6. The system of claim 1, wherein said signal accumulation unit includes memory storing a component motion database, and logic adapted to compare data for comparing data from the sensor to data in the component motion database to produce interpreted data based on one or more component motions in the component motion database, for detection of members of a set of pre-specified gestures, and said packaged data comprises said interpreted data.

7. The device of claim 1, including said host computer, the host computer including a presentation program which accepts commands concerning navigation within a presentation file, and including resources for interpreting the packaged data to identify a resulting signal, and for sending the resulting signal to the presentation program.

8. The device of claim 1, wherein the signal accumulation unit includes a bus, a microcontroller unit and a watchdog timer.

9. The system of claim 8, wherein the signal accumulation unit includes comparator logic comparing input sequences of data to produce packaged data.

10. The system of claim 1, including an orientation mark on the laser pointer.

11. The system of claim 1, wherein the laser pointer includes a housing, at least a portion of which is non-metallic allowing transmission of radio signals.

12. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one member of said set of pre-specified gestures includes a left to right flick of the laser pointer defined by motion from left to right with reference to the beam line exceeding one or both of a threshold velocity or a threshold acceleration, and including translating data indication detection of said left to right flick into a command for the presentation program to move to a next page in the presentation program.

13. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a right to left flick of the laser pointer defined by motion from right to left with reference to the beam line exceeding one or both of a threshold velocity or a threshold acceleration, and including translating data indication detection of said right to left flick into a command for the presentation program to move to a previous page in the presentation program.

14. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a slow forward movement of the laser pointer defined by motion parallel to and in a same direction as the beam line exceeding one or both of a first threshold velocity or a first threshold acceleration and below one or both of a second threshold velocity or a second threshold acceleration, and including translating data indication detection of said slow forward movement into a command for the presentation program to zoom in on a current page in the presentation program.

15. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a slow backward movement of the laser pointer defined by motion parallel to, and in an opposite direction as, the beam line exceeding one or both of a first threshold velocity or a first threshold acceleration and below one or both of a second threshold velocity or a second threshold acceleration, and including translating data indication detection of said slow backward movement into a command for the presentation program to zoom out on a current page in the presentation program.

16. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a slow upward movement of the laser pointer defined by an upward motion orthogonal to the beam line exceeding one or both of a first threshold velocity or a first threshold acceleration and below one or both of a second threshold velocity or a second threshold acceleration, and including translating data indicating detection of said slow upward movement into a command for the presentation program.

17. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a slow upward movement of the laser pointer defined by an upward motion orthogonal to the beam line exceeding one or both of a first threshold velocity or a first threshold acceleration and below one or both of a second threshold velocity or a second threshold acceleration, and including translating data indicating detection of said slow upward movement into a command for the presentation program.

18. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a slow downward movement of the laser pointer defined by a downward motion orthogonal to the beam line exceeding one or both of a first threshold velocity or a first threshold acceleration and below one or both of a second threshold velocity or a second threshold acceleration, and including translating data indicating detection of said slow downward movement into a command for the presentation program.

19. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a double left to right flick of the laser pointer defined by a sequence of motion within a pre-specified time interval including from two movements from left to right with reference to the beam line, both of said two movements exceeding one or both of a threshold velocity or a threshold acceleration, and including translating data indication detection of said double left to right flick into a command for the presentation program.

20. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a double right to left flick of the laser pointer defined a sequence of motion within a pre-specified time interval including from two movements from right to left with reference to the beam line, both of said two movements exceeding one or both of a threshold velocity or a threshold acceleration, and including translating data indication detection of said right to left flick into a command for the presentation program.

21. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a clockwise circle motion of the laser pointer defined by clockwise movement with reference to the beam line having a radius orthogonal to the beam line, and exceeding one or both of a threshold velocity or a threshold acceleration, and including translating data indicating detection of said clockwise circle motion into a command for the presentation program.

22. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a counter-clockwise circle motion of the laser pointer defined by counter-clockwise movement with reference to the beam line having a radius orthogonal to the beam line, and exceeding one or both of a threshold velocity or a threshold acceleration, and including translating data indicating detection of said counter-clockwise circle motion into a command for the presentation program.

23. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a double clockwise circle motion of the laser pointer defined by a sequence of motion within a pre-specified time interval including two clockwise movements with reference to the beam line having a radius orthogonal to the beam line, and exceeding one or both of a threshold velocity or a threshold acceleration, and including translating data indicating detection of said double clockwise circle motion into a command for the presentation program.

24. The system of claim 1, wherein said signal accumulation unit includes memory storing a component motion database, and logic adapted to compare data from the sensor to data in the component motion database to produce interpreted data based on one or more component motions in the component motion database, indicating detection of members of a set of pre-specified gestures, in which one of said set of pre-specified gestures includes a double counter-clockwise circle motion of the laser pointer defined by a sequence of motion within a pre-specified time interval including two counter-clockwise movements with reference to the beam line having a radius orthogonal to the beam line, and exceeding one or both of a threshold velocity or a threshold acceleration, and including translating data indicating detection of said double counter-clockwise circle motion into a command for the presentation program.

25. The system of claim 1, including a switch mounted on the laser pointer with a pre-specified orientation relative to the sensor, and logic responsive to the switch to delineate data about movement of the pointer to be used for detection of gestures.

26. A laser pointer system kit comprising
a laser on a hand held pointer configured to emit a beam on a beam line;
a motion sensor attached to a pointer;
a signal accumulation unit connected to the motion sensor providing data representing a relative position of the pointer;
the signal accumulation unit including logic for packaging data about the movement of the pointer sensed at the sensor to produce packaged data;
a communication interface for communication with a host computer by which the packaged data is sent to the host computer; and
a computer program stored on a machine readable medium, including executable programs supporting communication via the communication interface.

27. The system of claim 26, wherein the computer program includes a Bluetooth driver program and a command translator program.

28. A method for controlling a presentation program executing on a computer, including:
producing data representing motion of a laser pointer configured to emit a beam on a beam line, using a motion sensor mounted on the pointer;
processing the data to detect gestures matching a member of a set of pre-specified gestures;
composing and sending a message from the pointer to a host computer in response to detection of a member of the set of pre-specified gestures; and
controlling a presentation program running on the host computer in response to said message.

29. The method of claim 28, wherein said sensor comprises a MEMS sensor.

30. The method of claim 28, wherein said processing includes comparing said data representing motion to data in a component motion database to produce interpreted data, and said packaged output comprises said interpreted data.

31. The method of claim 28, wherein one of said set of pre-specified gestures includes a left to right flick of the laser pointer defined by motion from left to right with reference to the beam line exceeding one or both of a threshold velocity or a threshold acceleration, and including translating data indication detection of said left to right flick into a command for the presentation program to move to a next page in the presentation program.

32. The method of claim 28, wherein one of said set of pre-specified gestures includes a right to left flick of the laser pointer defined by motion from right to left with reference to the beam line exceeding one or both of a threshold velocity or a threshold acceleration, and including translating data indication detection of said right to left flick into a command for the presentation program to move to a previous page in the presentation program.

33. The method of claim 28, wherein one of said set of pre-specified gestures includes a slow forward movement of the laser pointer defined by motion parallel to and in a same direction as the beam line exceeding one or both of a first threshold velocity or a first threshold acceleration and below one or both of a second threshold velocity or a second threshold acceleration, and including translating data indication detection of said slow forward movement into a command for the presentation program to zoom in on a current page in the presentation program.

34. The method of claim 28, wherein one of said set of pre-specified gestures includes a slow backward movement of the laser pointer defined by motion parallel to, and in an opposite direction as, the beam line exceeding one or both of a first threshold velocity or a first threshold acceleration and below one or both of a second threshold velocity or a second threshold acceleration, and including translating data indication detection of said slow backward movement into a command for the presentation program to zoom out on a current page in the presentation program.

35. The method of claim 28, wherein one of said set of pre-specified gestures includes a slow upward movement of the laser pointer defined by an upward motion orthogonal to the beam line exceeding one or both of a first threshold velocity or a first threshold acceleration and below one or both of a second threshold velocity or a second threshold acceleration, and including translating data indicating detection of said slow upward movement into a command for the presentation program.

36. The method of claim 28, wherein one of said set of pre-specified gestures includes a slow downward movement of the laser pointer defined by a downward motion orthogonal to the beam line exceeding one or both of a first threshold velocity or a first threshold acceleration and below one or both of a second threshold velocity or a second threshold acceleration, and including translating data indicating detection of said slow downward movement into a command for the presentation program.

37. The method of claim 28, wherein one of said set of pre-specified gestures includes a double left to right flick of the laser pointer defined by a sequence of motion within a pre-specified time interval including from two movements from left to right with reference to the beam line, both of said two movements exceeding one or both of a threshold velocity or a threshold acceleration, and including translating data indication detection of said double left to right flick into a command for the presentation program.

38. The method of claim 28, wherein one of said set of pre-specified gestures includes a double right to left flick of the laser pointer defined a sequence of motion within a pre-specified time interval including from two movements from right to left with reference to the beam line, both of said two movements exceeding one or both of a threshold velocity or a threshold acceleration, and including translating data indication detection of said right to left flick into a command for the presentation program.

39. The method of claim 28, wherein one of said set of pre-specified gestures includes a clockwise circle motion of the laser pointer defined by clockwise movement with reference to the beam line having a radius orthogonal to the beam line, and exceeding one or both of a threshold velocity or a threshold acceleration, and including translating data indicating detection of said clockwise circle motion into a command for the presentation program.

40. The method of claim 28, wherein one of said set of pre-specified gestures includes a counter-clockwise circle motion of the laser pointer defined by counter-clockwise movement with reference to the beam line having a radius orthogonal to the beam line, and exceeding one or both of a threshold velocity or a threshold acceleration, and including translating data indicating detection of said counter-clockwise circle motion into a command for the presentation program.

41. The method of claim 28, wherein one of said set of pre-specified gestures includes a double clockwise circle motion of the laser pointer defined by a sequence of motion within a pre-specified time interval including two clockwise movements with reference to the beam line having a radius orthogonal to the beam line, and exceeding one or both of a threshold velocity or a threshold acceleration, and including translating data indicating detection of said double clockwise circle motion into a command for the presentation program.

42. The method of claim 28, wherein one of said set of pre-specified gestures includes a double counter-clockwise circle motion of the laser pointer defined by a sequence of motion within a pre-specified time interval including two counter-clockwise movements with reference to the beam line having a radius orthogonal to the beam line, and exceeding one or both of a threshold velocity or a threshold acceleration, and including translating data indicating detection of said double counter-clockwise circle motion into a command for the presentation program.

43. The method of claim 28, wherein said resulting signal is translated to a command for the presentation program to jump from one point in the presentation to the next point.

44. The method of claim 28, wherein said resulting signal is translated to a command for the presentation program to control video functions in the presentation program.

45. The method of claim 28, wherein said resulting signal is translated to a command for the presentation program to control audio loudness functions in the presentation program.
